(19) United States
(12) Patent Application Publication
(10) Pub. No.: US 2010/0259947 A1
(43) Pub. Date: Oct. 14, 2010

(54) Vehicle Light with Trademark Display

(76) Inventor: Robert A. Dolan, Gilbert, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 12/423,184

(22) Filed: Apr. 14, 2009

(51) Int. Cl. B60Q 1/00; F21K 7/00

(52) U.S. Cl. 362/509; 362/544; 362/545

(57) ABSTRACT

A vehicle light assembly is provided for a vehicle rented by a rental business. The assembly includes a light frame adapted for mounting to the rental vehicle, a light source such as an LED light source and a lens covering the light source. The light frame can be for a tail light, such as a brake light or a turn signal. The lens displays a visible indicium when the light source is energized. The indicium can be in the form of an advertisement, such as an advertisement for goods or services of the rental business, or in the form of a trademark relating to the goods or services of the rental business.

### BACKGROUND

The present invention relates to vehicle lighting. More particularly, it relates to a vehicle light that incorporates means for displaying a visible message, identifier or trademark when the light is illuminated.

In the moving equipment rental business, vehicles such as trucks, large vans or trailers have lights that are subject to theft and are frequently stolen. Such theft has become even more frequent as the use of LED vehicle lighting has grown because LED lights are more costly than previous incandescent lights.

In addition, in the moving equipment rental business it is desirable to utilize rented vehicles to advertise the products and services of the rental business.

It is an object of the present invention to provide a light assembly for a vehicle, such as a rear turn light or tail light assembly, that is less subject to theft than previously known vehicle lights.

It is still another object of the present invention to provide a light assembly that can be used to advertise products and services.

It is yet another object of the invention to provide such a light that can replace a standard vehicle light.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided a vehicle light assembly for a vehicle rented by a rental business. The vehicle light assembly includes a light frame adapted for mounting to the rental vehicle, a light source and a lens covering the light source. The lens is adapted to display a visible indicium when the light source is energized. The indicium can be in the form of an advertisement, such as an advertisement for goods or services of the rental business. In one preferred embodiment, the indicium includes a trademark relating to the goods or services of the rental business. The light frame can be adapted for mounting to the rental vehicle as a tail light, such as a brake light or a turn signal. In one particularly advantageous embodiment, the light source is an LED light source.

In another embodiment, a vehicle light assembly for a rental vehicle includes a light frame adapted for mounting to the rental vehicle as a tail light frame. The assembly includes a plurality of light sources. Energizing circuitry is provided for lighting the plurality of light sources in the pattern of an indicium for advertising goods or services related to the rental vehicle. In this embodiment, the light assembly displays a visible representation of the advertising indicium when the light source is energized.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

FIG. 1 shows a front view of one embodiment of a round tail light assembly according to the present invention, wherein the light source provides backlighting for the indicium.

FIG. 2 shows a front view of the tail light assembly of FIG. 1, with the lens disassembled from the light frame.

FIG. 3 shows a perspective view of a rear portion of a rental vehicle, i.e. a truck, with the tail light assembly of FIG. 1.

FIG. 4 shows a perspective view of another embodiment of a tail light assembly according to the present invention, wherein the light source includes a plurality of LED's arranged in the pattern of the indicium.

FIG. 5 shows a top view of the tail light assembly of FIG. 4.

FIG. 6 shows a front view of the tail light assembly of FIG. 4.

FIG. 7 is a side view of the tail light assembly of FIG. 4, showing the plurality of LED's within the assembly.

FIG. 7A shows a portion of FIG. 7 in more detail.

### DETAILED DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

Referring to the drawings, a vehicle light assembly according to the present invention is generally designated by reference number 10. The vehicle light assembly 10 includes a light frame 12 in which is disposed a light source 14, such as an incandescent light source or one or more light emitting diodes (LEDs). A lens 16 fits onto the frame 12 and covers the light source 14. The vehicle light assembly 10 includes an indicium 18 that is suitable for advertising goods or services related to a rental vehicle 30. In a preferred embodiment, the indicium is in the form of a trademark, which functions to advertise the related goods and services as well as an identifier to associate the light assembly 10 with the vehicle 30 on which the light assembly 10 is mounted. The light assembly is adapted to visibly highlight or display the indicium 18 when the light source 14 is energized. The light assembly 10 can be used for advertising and can be used to prevent theft of tail lights because the lighted message will be a unique identifier that can be associated with the owner of the rental vehicle.

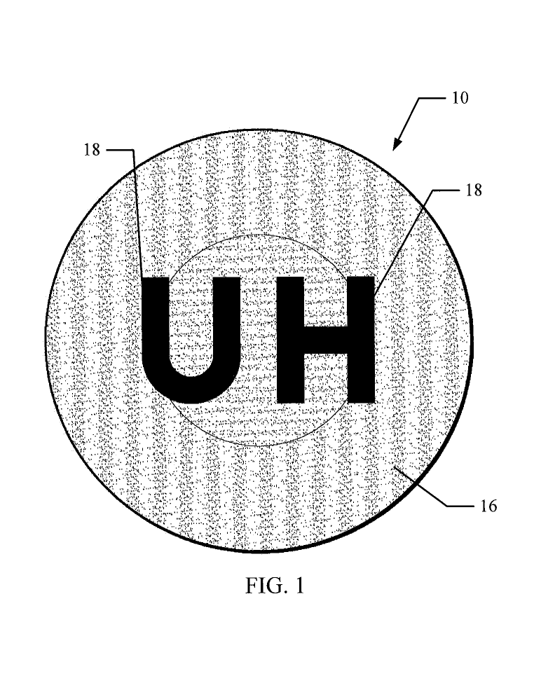

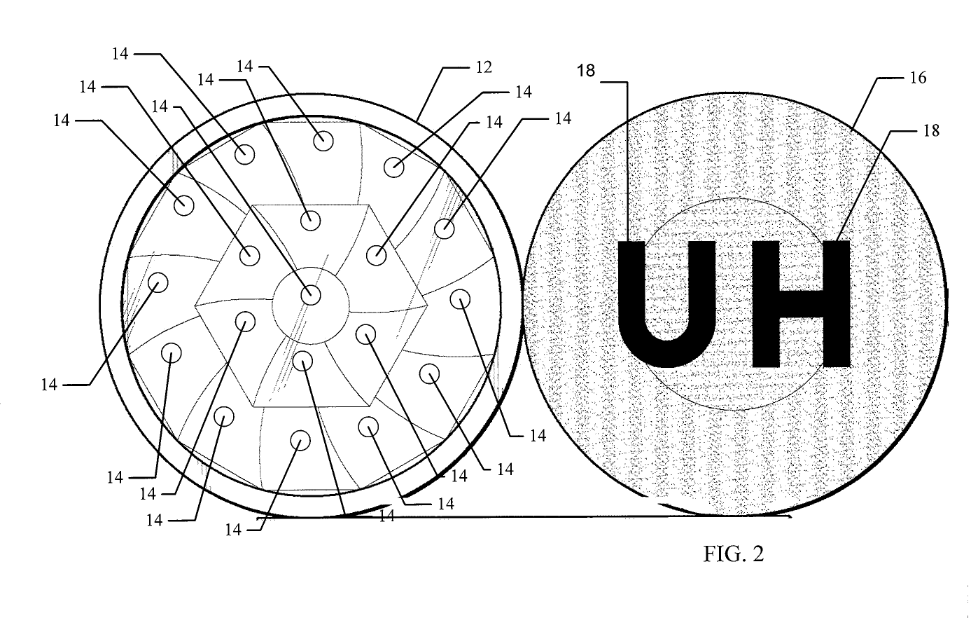

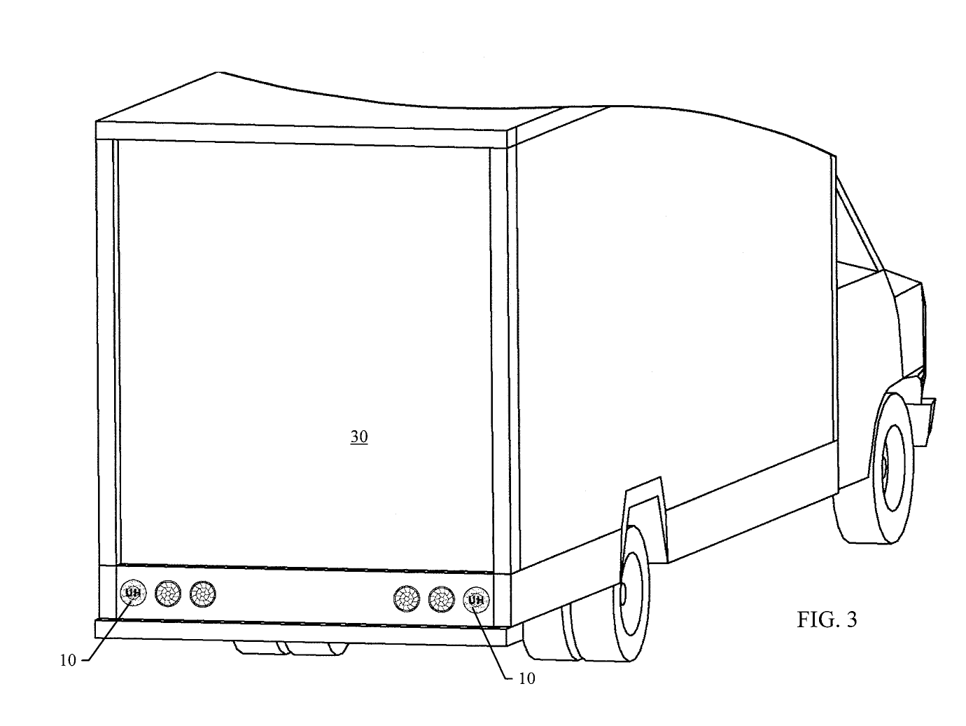

FIGS. 1-3 illustrate one embodiment of a vehicle light assembly according to the present invention, which is configured as a round tail light. The indicium 18 is formed by disposing on the inside of the lens 16 an opaque material in the desired pattern. When the light sources 14 are energized, the opaque material of the indicium 18 blocks the transmission of light so that the indicium is backlighted, thereby highlighting the visibility of the indicium.

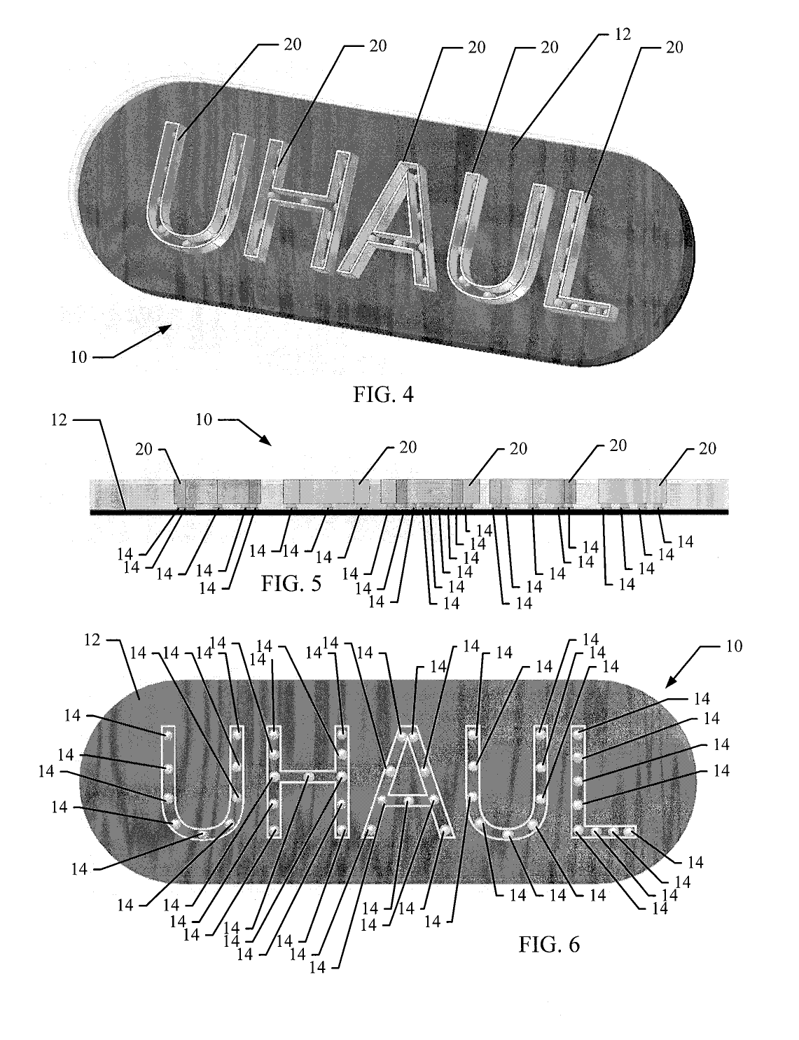

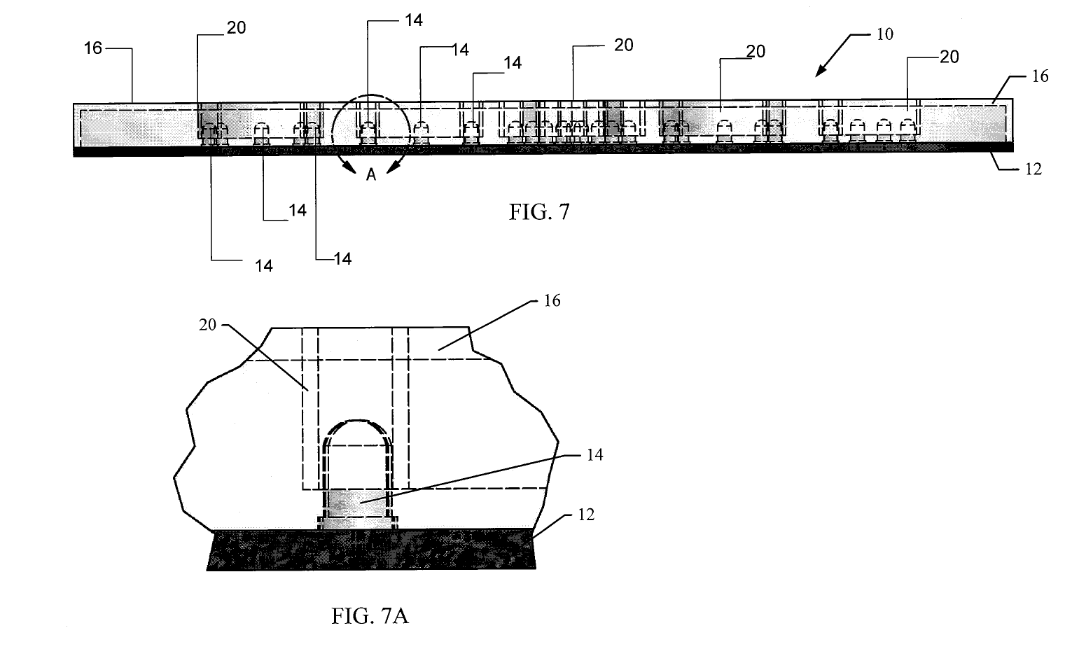

FIGS. 4-7 illustrate another embodiment of a vehicle light assembly according to the present invention. In this embodiment, a plurality of LED's 14 is disposed within the assembly within channels 20 that are arranged in a desired indicium pattern. The walls of the channels are formed of an opaque material. When the light sources 14 are energized, the opaque material of the channels 20 blocks the lateral dispersion of light and directs or allows transmission of the light through the lens 16 in the pattern of the indicium. In this embodiment, the light assembly displays a visible representation of the advertising indicium when the light source is energized. This embodiment is more effective when the purpose of the light is used for advertising.

Another embodiment of a light assembly 10 according to the present invention includes lighting circuitry (not shown) that energizes selected lights 14 when the turn signal or brake signal is actuated. In this configuration, multiple LEDs or other lights 14 can be selectively illuminated to display the message (e.g., advertising) when the turn signal or brake light is actuated.

Although the light assemblies shown in FIGS. 1-7 are adapted for use as a tail light for a truck or trailer, it will be understood that in other embodiments, a light assembly according to the invention can be used to replace any exterior vehicle light, including a rear turn light or a tail light, as well as an interior light. The indicium displayed through the light can be used either as advertising or to prevent theft.

From the foregoing, it can be seen that the apparatus of the present invention possesses numerous advantages. It provides a deterrent to theft of vehicle lights because the indicium incorporated into the light can act as an identifier that associates the light with a particular vehicle, rental company or owner. Once the light assembly is illuminated, it will be obvious to the viewer that the light was stolen. In addition, the light assembly can be used to display a trademark or other advertising message.

Upon reading this disclosure, those skilled in the art will appreciate that various changes and modifications may be made to the preferred embodiments of the invention and that such changes and modifications may be made without departing from the spirit of the invention. For example, the light assembly can be fabricated in any shape or size suitable for a vehicle light. Therefore, the invention in its broader aspects is not limited to the specific details, representative devices, and illustrative examples shown and described. Accordingly, departures may be made from such details without departing from the spirit or scope of the general inventive concept.

What is claimed is:

1. A vehicle light assembly for a vehicle rented by a rental business, the vehicle light comprising:
a light frame adapted for mounting to the rental vehicle;
a light source; and
a lens covering the light source and being adapted to display a visible indicium when the light source is energized.

2. The vehicle light assembly of claim 1 wherein the indicium is in the form of an advertisement.

3. The vehicle light assembly of claim 2 wherein the advertisement is an advertisement for goods or services of the rental business.

4. The vehicle light assembly of claim 1 wherein the indicium is in the form of a trademark.

5. The vehicle light assembly of claim 2 wherein the trademark relates to the goods or services of the rental business.

6. The vehicle light assembly of claim 1 wherein the light frame is adapted for mounting to the rental vehicle as a tail light.

7. The vehicle light assembly of claim 1 wherein the light frame is adapted for mounting to the rental vehicle as a brake light.

8. The vehicle light assembly of claim 1 wherein the light frame is adapted for mounting to the rental vehicle as a turn signal.

9. The vehicle light assembly of claim 1 wherein the light source comprises an LED.

10. A vehicle light assembly comprising:
a light frame adapted for mounting to a vehicle;
a light source;
a channel adapted to direct transmission of light from the light source, wherein the channel is disposed in the pattern of an indicium; and
a lens covering the light source;
whereby the light assembly displays a visible representation of the indicium when the light source is energized.

11. The vehicle light assembly of claim 10 wherein the indicium comprises an advertisement.

12. The vehicle light assembly of claim 11 wherein the advertisement relates to the goods or services of a business related to the vehicle.

13. The vehicle light assembly of claim 10 wherein the indicium comprises a trademark.

14. The vehicle light assembly of claim 13 wherein the trademark relates to the goods or services of a business related to the vehicle.

15. The vehicle light assembly of claim 10 wherein the light frame is adapted for mounting to the vehicle as a tail light.

16. The vehicle light assembly of claim 10 wherein the light frame is adapted for mounting to the vehicle as a brake light.

17. The vehicle light assembly of claim 10 wherein the light frame is adapted for mounting to the vehicle as a turn signal.

18. The vehicle light assembly of claim 10 wherein the light source comprises an LED.

19. A vehicle light assembly for a rental vehicle, the light assembly comprising:
a light frame adapted for mounting to the rental vehicle as a tail light frame;
a plurality of light sources; and
means for lighting the plurality of light sources in the pattern of an indicium for advertising goods or services related to the rental vehicle;
whereby the light assembly displays a visible representation of the advertising indicium when the light source is energized.

20. The vehicle light assembly of claim 19 wherein the indicium is in the form of an identifier associated with the rental vehicle.

21. The vehicle light assembly of claim 19 wherein the trademark relates to the goods or services of the rental business.

22. The vehicle light assembly of claim 19 wherein the light frame is adapted for mounting to the rental vehicle as a brake light.

23. The vehicle light assembly of claim 19 wherein the light frame is adapted for mounting to the rental vehicle as a turn signal.

24. The vehicle light assembly of claim 19 wherein the light source comprises an LED.
